(19) United States
(12) Patent Application Publication
(10) Pub. No.: US 2004/0244369 A1
(43) Pub. Date: Dec. 9, 2004

(54) Drive with a hydro machine

(76) Inventors: Johann Ballert, Vuadens (CH); Andre Droux, Chatel-St. Denis (CH)

Correspondence Address: Rocco S. Barrese, Esq., DILWORTH & BARRESE, LLP, 333 Earle Ovington Blvd., Uniondale, NY, 11553, US

(21) Appl. No.: 10/772,925

(22) Filed: Feb. 5, 2004

(30) Foreign Application Priority Data
Feb. 5, 2003 (DE) 103 04 665.8

(51) Int. Cl. F16D 31/02

(52) U.S. Cl. 60/452

(57) ABSTRACT

The present invention relates to a drive comprising a hydro machine whose injection volume is changeable, comprising an adjustment device for the changing of the injection volume of the hydro machine, comprising a first control valve which is in communication with the adjustment device and which is connected such that it effects a position of the adjustment device causing a low injection volume in a first position and effects a position of the adjustment device causing—compared with this—a large injection volume in a second position. A change in the brake torque of the hydro machine is possible in accordance with the invention in that a control device, preferably a second control valve, is provided on which an inlet pressure acts at the inlet side and which is in communication with a first control connection of the first control valve on the outlet side, with a pressure loading of the first control connection exerting a force directed in the second position of the first control valve, and with the second control valve connecting the inlet side to the first control connection of the first control valve in a region of low performance requirements.

The present invention relates to a drive comprising a hydro machine whose injection volume is changeable, comprising an adjustment device for the changing of the injection volume of the hydro machine, comprising a first control valve which is in communication with the adjustment device on the outlet side and which is connected such that it effects a position of the adjustment device causing a low injection volume in a first position and effects a position of the adjustment device causing—compared with this—a large injection volume in a second position.

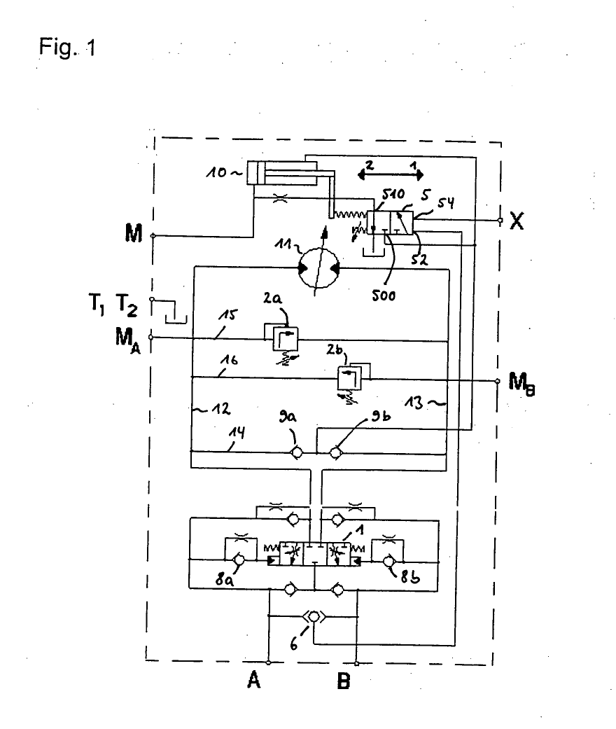

Such drives are used, for example, as propulsion drives. FIG. 1 shows a hydraulic diagram of a known drive with a hydraulic motor 11 whose injection volume can be changed. The adjustment of the injection volume of the hydraulic motor 11 takes place by means of the adjustment device 10 whose piston space shown on the left is in communication with the connection 510 of a control valve 5. The control valve 5 has a control connection 52 to which pressure is applied via the shuttle valve 6. The shuttle valve 6 is in communication with the inflow line and the outflow line of the drive or with the corresponding working connections A, B.

The control valve 5 has a further control connection 54 which is controllable via a control connection X.

At its inlet side 500, the control valve 5 is in communication with the line 14 which extends between the working lines 12, 13 of the hydraulic motor 11 and which is designed with the check valves 9a and 9b. These ensure that the higher pressure of the pressures in the working lines 12, 13 is applied at the inlet side 500 of the control valve 5.

As can further be seen in FIG. 1, the piston space of the adjustment device 10 shown on the right is also in communication with the inlet side 500 of the control valve 5 and thus also with the aforesaid check valve arrangement 9a, 9b or with the line 14.

Furthermore, the lines 15, 16 connecting the working lines 12, 13 are provided, in which pre-set pressure restricting valves 2a, 2b are arranged.

The arrangement furthermore includes the brake valve 1 which, depending on its position, connects the backflow of the hydraulic motor 11 either with the connection A or B or which is in the blocking position shown in FIG. 1. The brake valve 1 is controlled via the restrictor check valves 8a, 8b.

The operation of the arrangement shown in FIG. 1 takes place as follows:

When moving off, the hydraulic motor 11 is supplied by a pump via the slider at the connection A for forward travel and at the connection B for reverse travel. The connections can naturally also be swapped over in comparison with this.

In forward travel, the high pressure signal at the pump side is applied via the shuttle valve 6 to the control valve 5 or to its control connection 52. This has the consequence that the control valve is displaced from the position shown in FIG. 1 in the direction 2 so that the inlet 500 is connected to the piston space of the adjustment device 10 shown on the left. The same pressure is also applied in the piston space 10 shown on the right in accordance with the arrangement selected. Due to the larger piston area of the left hand piston space, the piston of the adjustment device 10 is displaced to the right in accordance with FIG. 1, which has the consequence that the injection volume of the hydraulic motor increases accordingly.

The pressure applied to the connection A effects the movement of the brake valve to the right in accordance with FIG. 1 via the restrictor check valve 8a, which has the consequence that the working line 13 of the hydraulic motor 11 is connected to the connection B via the brake valve 1 so that a corresponding outflow of the hydraulic medium can take place. The supply off the hydraulic motor 11 takes place via the connection A in accordance with the said embodiment. The pressure present here is applied to the inlet side of the hydraulic motor 11 and also to the check valve 9a. In accordance with the selected valve arrangement, the same pressure is applied to the inlet side 500 of the control valve 5 and in the piston space of the adjustment device 10 shown on the right.

If the inflow pressure at the shuttle valve 6 falls to a specific value, for example on the transition from the acceleration to a travel with constant speed, the control valve 5 moves in the direction 1 until the position shown in FIG. 1 is reached. In this position, the piston space of the adjustment device 10 shown on the left is relieved and the piston is correspondingly displaced to the left. This has the consequence that the hydraulic motor 11 is operated at a low injection volume.

If the pressure at connection A falls further, for example, on the transition from the drive manner on the flat to valley drive, this has the result that the brake valve 1 responds and moves to the position shown in FIG. 1. The hydraulic motor backflow oil thereby starts to be restricted and is finally completely blocked. The hydraulic motor 11 now acts as a hydraulic pump and accordingly conveys hydraulic medium of a lower pressure to a higher pressure level which again flows back to the inlet side of the hydraulic motor working as a hydraulic pump in the circuit. The pressure restricting valves 2a, 2b ensure that the pressure does not increase beyond the pre-set value in this operating manner.

The brake torque produced in this operating manner is produced in accordance with the previously described manner of function at a low injection volume (position of the control valve as shown in FIG. 1) of the hydro machine and at a comparatively high pressure difference Δp. Due to the comparatively low injection volume, a comparatively large pressure difference Δp is required to produce a pre-determined brake torque.

The disadvantage arises from this, on the one hand, that the corresponding operation, for example of an excavator, is associated with a large volume of noise due to the high pressure difference. It results as a further disadvantage that the brake torque of the arrangement shown is substantially constant, since it is determined by the constant minimum injection volume and the pre-set pressure difference.

It is therefore the object of the present invention to further develop a drive of the kind initially mentioned such that the brake torque of the hydraulic machine is changeable.

This object is satisfied by a drive having the features of claim 1. Advantageous embodiments of the invention result from the dependent claims.

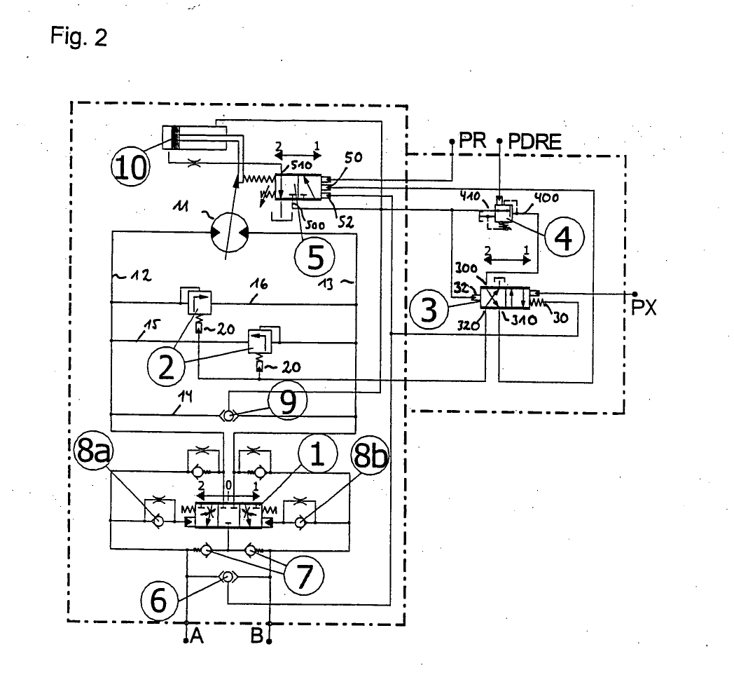

The solution in accordance with the invention, of which an exemplary embodiment is shown in FIG. 2, is based on the fact that a control device is provided, preferably in the form of a second control valve, on which an inlet pressure acts at the inlet side and which is in communication with a first control connection of the first control valve on the outlet side, with a pressure loading of the first control connection exerting a force directed in the second position of the first control valve, and with the control device, preferably the second control valve, being connected such that it connects the inlet side to the first control connection of the first control valve in a region of low performance requirements. The advantage is thereby achieved that at a low performance request, i.e. for example in braking operation, the first control valve is movable into its second position, which has the consequence that the injection volume of the hydro machine, and thus also the brake torque, is increased. A lower pressure difference is correspondingly required at a constant brake torque. The control device or the second control valve exerts the function that a corresponding control connection of the first control valve is loaded by pressure at least in the region of low performance request, whereby the said position change of the first valve, and thus also the position of the adjustment device, is changeable in the desired manner. In a preferred embodiment, the said region of lower performance is achieved with valley travel.

The advantage arises from this that in the valley travel braking can take place not only with a minimum injection volume, but also with a maximum injection volume. Accordingly, a lower pressure difference via the hydro machine is sufficient to achieve a desired brake torque, which has the advantage that the noise volume during the braking procedure is correspondingly reduced.

The hydro machine can be designed as a hydraulic motor. This can be designed as an axial piston motor in swash plate construction. However, any other embodiments of the hydro machine are also feasible.

In a preferred aspect of the present invention, the first control valve has a second control connection acting in the same manner with its first control connection which is in communication with a first control connection of the second control valve such that both control connections have the same control pressure applied to them.

Provision can be made in this process for a line having a shuttle valve to extend between an inflow and an outflow line of the drive by means of which the control pressure at the second control connection of the first control valve and at the first control connection of the second control valve can be applied.

In a further aspect of the invention, provision is made for the second control valve to have a second control connection acting counter to the first control connection and for the second control connection to be in communication with the inlet side of the first control valve such that the same pressure is applied to the inlet side of the first control valve and to the second control connection of the second control valve.

Provision can be made for a line extending between the working lines of the hydraulic motor and having a shuttle valve to be provided, with the inlet side of the first control valve and the second control connection of the second control valve being able to be loaded with pressure by means of the shuttle valve.

In a preferred aspect of the present invention, a pressure-reducing valve is provided which is in communication with the inlet side of the second control valve on the outlet side. At a low performance requirement, in which the inlet side of the second control valve is in communication with the first control connection of the first control valve, the pressure of the pressure-reducing valve on the outlet side is accordingly applied via the second control valve to the first control connection of the first control valve.

Provision can furthermore be made for the pressure-reducing valve to be in communication with the inlet side of the first control valve on the inlet side. In this case, the same pressure is applied to the inlet side of the first control valve, to the inlet side of the pressure-reducing valve and to the second control connection of the second control valve.

In a further aspect of the invention, provision is made for the second control valve to be in communication with the control connection of one or more pressure restricting valves, with the pressure restricting valves being provided in the lines connecting working lines of the hydro machine and the second control valve being connected such that its inlet side can be connected to the control connections of the pressure restricting valves. It can be achieved in this manner that the pressure level of the pressure restricting valves can be changed and correspondingly increased, for example at a high required torque. It is possible in this case, with a fully pivoted out hydro machine, to achieve a maximum brake torque which is based on the product of the maximum injection volume and the maximum pressure difference. The brake torque is thus not only changeably by the adjustment of the first control valve and thus by the change of the injection volume, but also by a direct control of the pressure restricting valves.

Provision can furthermore be made for the second control valve to be connected such that it switches the control connections of the pressure restricting valves without pressure in the position connecting its inlet side to the first control connection of the first control valve and switches the first control connection of the first control valve without pressure in the position connecting the inlet side with the control connections of the pressure restricting valves. It can thereby be achieved that, in particular with low performance requirements, the hydraulic motor is operated at a low pressure difference and at a high injection volume, whereas with high load requirements operation is possible at a high injection volume and at a high pressure difference. The large injection volume results at a high performance requirement from a correspondingly large control pressure at the first control connection of the first control valve.

In a further aspect of the present invention, a brake valve is provided which is in a closed position at a low performance requirement and blocks the backflow of the hydro machine in this position.

Furthermore, pressure lines can be provided by means of which the first control valve and/or the second control valve and/or the pressure-reducing valve can be overridden.

Further details and advantages of the present invention will be explained in more detail with reference to an embodiment shown in the drawing.

There are shown:

FIG. 1: a circuit diagram of the drive with a hydraulic motor and a control in accordance with the prior art; and

FIG. 2: a circuit diagram of the drive with a hydraulic motor with a control in accordance with the present invention.

FIG. 2 shows the circuit diagram of the drive in accordance with the invention with a hydraulic motor 11 whose injection volume is adjustable as well as the associated control.

Deviating from the design explained with respect to FIG. 1, the drive in accordance with the invention of the embodiment in accordance with FIG. 2 has a pressure-reducing valve 4 and a second control valve 3. Furthermore, pressure restricting valves 2 are provided which are adjustable via corresponding control connections 20.

As can be seen from FIG. 2, the connection 310 of the second control valve 3 is in communication with the first control connection 50 of the first control valve 5.

The operation of the arrangement shown in FIG. 2 takes place as follows:

When moving off, the hydraulic motor 11 is supplied by a pump via the slider at the connection A for forward travel and at the connection B for reverse travel. The connections can naturally also be swapped over.

During the forward travel, the high pressure signal on the pump side is applied via the shuttle valve 6 to the second control valve 3 (control connection 30), which is designed as a way valve, and to the first control valve 5 (control connection 52). The same control pressure is thus applied to the first control connection 30 of the second control valve 3 and to the second control connection 52 of the first control valve 5. Via the shuttle valve 9, the pressure-reducing valve 4 is supplied with pressure on its inlet side 410, the second control section 32 of the second control valve 3 is supplied with pressure and the inlet side 500 of the first control valve 5 is supplied with pressure. This pressure is furthermore applied to the piston space of the adjustment device 10 shown on the right. It is ensured on the basis of the connection of the inlet side 410 of the pressure-reducing valve 4 to the shuttle valve 9 that the pressure-reducing valve 4 is fed with high pressure both during acceleration and during braking.

When moving off, the first control valve 5 moves on the basis of the correspondingly large pressure applied to the second control connection 52 in direction 2, i.e. in its left-hand end position in which the inlet side 500 is in communication with the connection 510 and thus with the piston space of the adjustment device 10 shown on the left. Due to the larger piston area in the piston space shown on the left, the adjustment device 10 is moved to the right and the injection volume of the hydraulic motor 11 is thus increased.

The control pressure applied during moving off to the shuttle valve 6 and thus also to the first control connection 30 of the second valve 3 furthermore has the effect that the second control valve 3 is likewise moved in direction 2 and thus into its left-hand end position. This movement takes place on the basis of the corresponding bias of the valve. The control pressures applied to the first control connection 30 and to the second control connection 32 of the second control valve 3 are identical in this manner of operation.

The movement of the second control valve 3 in direction 2 has the consequence that the outlet side 400 of the pressure-reducing valve 4 is now applied via the connections 300, 320 to the control connections 20 of the pressure restricting valves 2 which are arranged in the lines 15 and 16 which connect the working lines 12 and 13 of the hydraulic motor 11 with one another.

In this operating state, the hydraulic motor is set to maximum injection volume and the control pressure of the pressure reducing valve 4 brings the high pressure valves 2 to their maximum setting via the second control valve 3. It is thereby ensured that the hydraulic motor 11 emits the maximum torque. The hydraulic motor 11 only starts to turn, however, when the high pressure moves the brake valve 1 or the associated brake piston via the restrictor check valve 8a in direction 1. The backflow oil of the hydraulic motor 11 is thereby released to connection B via the brake piston or the brake valve 1 and the check valve 7.

If the inflow pressure at the shuttle valve 6 falls to a specific value, such as can be the case, for example, on the transition from acceleration to travel at constant speed, the first control valve 5 moves in direction 1 due to the falling control pressure at the second control connection 52, whereby the pivot angle and the injection volume of the hydraulic motor becomes smaller and the speed increases (high speed/low torque).

Reverse travel is achieved by swapping the connections A and B. This takes place analog to what was previously described.

On the transition from acceleration to travel at a constant speed, the second control valve 3 remains in its end position displaced in direction 2 so that the pressure restricting valves 2 continue to be loaded with pressure via the pressure-reducing valve 4.

On the transition from travel on the plane to valley travel, the pressure at the working connection A or in the corresponding infeed at forward travel falls even further. This results in the brake valve responding and moving into the neutral position 0 shown in FIG. 2. The hydraulic motor backflow oil thereby starts to be restricted up to complete blocking. The pressure restricting valves 2 then take over the maximum brake torque.

The hydraulic motor 11 now works as a hydraulic pump which conveys the hydraulic medium in the circuit via the pressure restricting valves 2.

The increase in the backflow pressure at the shuttle valve 9 and the simultaneous sinking of the inflow pressure at the shuttle valve 6 has the consequence that the second control valve 3 is moved in direction 1 and the first control valve 5 is moved in direction 2. In the said position of the second control valve 3, this connects the outlet side 400 of the pressure-reducing valve 4 via the connection 310 to the first control connection 50 of the first control valve 5, which has the consequence that this is moved in the direction 2 and the pivot angle of the hydraulic motor 11 accordingly goes to its maximum value or the injection volume is set to the maximum value. At the same time, the second control valve 3 relieves the control connections 20 of the pressure restricting valves 2 such that the pressure setting is correspondingly reduced. The brake torque nevertheless remains constant due to the correspondingly increased injection volume. The noise level reduces at this setting.

As can be seen from FIG. 2, the possibility exists of changing the high pressure setting by overriding (PR, PDRE, PX) of the second control valve 3 or of the pressuring reducing valve 4 such that the brake torque can be correspondingly varied. Generally, a brake torque of the motor resulting from the maximum injection volume and the maximum pressure setting of the pressure reducing valves is thus also possible.

When the first control valve 5 is overridden, the brake torque is further increased, since the valve moves in direction 2 in this case.

If a still higher brake torque without overriding is desired, the pressure at the shuttle valve 6 can be further increased by reversing the inflow pressure. Due to the corresponding increase in the pressure, the first control valve 5 is held in its second position in which a maximum pivot angle or injection volume results. The second control valve 3, however, moves in direction 2, whereby the pressure restricting valves 2 are set higher in pressure. An increase in the brake torque up to the maximum value results from this as required.

An embodiment without a pressure reducing valve 4 is also feasible in addition to the design of the arrangement in accordance with the invention described above. In this case, the control of the following valves takes place directly with the system high pressure. This means that in this case, the second control valve 3 and the pressure restricting valves 2 and the first control valve 5 must be designed and made suitable for high pressure.

Provision can furthermore be made for the response of the control valve 5 to take place with a delay so that a braking start takes place with a minimum injection volume so that the motor does not turn too fast at the start of the braking procedure. The delay can be adjustable via the control valve 5.

1. A drive comprising a hydro machine whose injection volume is changeable, comprising an adjustment device (10) for the changing of the injection volume of the hydro machine, comprising a first control valve (5) which is in communication with the adjustment device (10) on the outlet side and which is connected such that it effects a position of the adjustment device (10) causing a low injection volume in a first position and a position of the adjustment device (10) causing, compared thereto, a large injection volume in a second position,
wherein
a control device is provided on which an inlet pressure acts at the inlet side (300) and which is in communication with a first control connection (50) of the first control valve (5) on the outlet side (310), with a pressure loading of the first control connection (50) exerting a force directed in the second position of the first control valve (5), and the control device being connected such that it connects the inlet side (300) to the first control connection (50) of the first control valve (5) in a region of low performance requirements.

2. A drive in accordance with claim 1, wherein the hydro machine is designed as a hydraulic motor (11).

3. A drive in accordance with claim 2, wherein the hydraulic motor (11) is designed as an axial piston motor in swash plate construction.

4. A drive in accordance with any of the preceding claim 14, wherein the first control valve (5) has a second control connection (52) acting in the same manner with the first control connection (50) which is in communication with a first control connection (30) of the second control valve (3) such that both control connections (30, 52) are acted on with the same control pressure.

5. A drive in accordance with claim 4, wherein it has an inflow and an outflow line between which a line extends which has a shuttle valve (6) via which the control pressure can be applied to the second control connection (52) of the first control valve (5) and to the first control connection (30) of the second control valve (3).

6. A drive in accordance with claim 14, wherein the second control valve (3) has a second control connection (32) acting counter to the first control connection (30) and the second control connection (32) is in communication with the inlet side (500) of the first control valve (5) such that the same pressure is applied to the inlet side (500) of the first control valve (5) and to the second control connection (32) of the second control valve (3).

7. A drive in accordance with claim 6, wherein a line (14) extending between the working lines (12,13) of the hydro machine is provided in which a shuttle valve (9) is arranged via which the inlet side (500) of the first control valve (5) and the second control connection (32) of the second control valve (3) can have pressure applied.

8. A drive in accordance with claim 14, wherein a pressure-reducing valve (4) is provided which is in communication at the outlet side (400) with the inlet side (300) of the second control valve (3).

9. A drive in accordance with claim 8, wherein the pressure-reducing valve (4) is in communication with the inlet side (500) of the first control valve (5) on the inlet side (410).

10. (Currently amended) A drive in accordance with claim 14, wherein the second control valve (3) is in communication with the control connection (20) of one or more pressure restricting valves (2), with the pressure restricting valves (2) being arranged in the lines (15, 16) connecting the working lines (12, 13) if the hydro machine and the second control valve (3) being connected such that its inlet side (300) can be connected to the control connections (20) of the pressure restricting valves (2).

11. A drive in accordance with claim 10, wherein the second control valve (3) is connected such that it switches the pressure restricting valves (2) without pressure in the position connecting the inlet side (300) to the first control connection (50) of the first control valve (5) and switches the first control connection (50) of the first control valve (5) without pressure in the position connecting the inlet side (300) with the control connections (20) of the pressure restricting valves (2).

12. A drive in accordance with claim 1, wherein a brake valve (1) is provided which is in its closed position at a low performance requirement and blocks the backflow of the hydro machine in this position.

13. A drive in accordance with claim 8, where the pressure lines are provided by which the first control valve (5) and/or the second control valve (3) and/or the pressure reducing valve (4) can be overridden.

14. A drive in accordance with claim 1, wherein said control device is a second control valve (3).

15. A drive in accordance with claim 14, wherein the hydro machine is designed as a hydraulic motor (11).

16. A drive in accordance with claim 15, wherein the hydraulic motor (11) is designed as an axial piston motor in swash plate construction.

17. A drive in accordance with claim 4, wherein the second control valve (3) has a second control connection (32) acting counter to the first control connection (30) and the second control connection (32) is in communication with the inlet side (500) of the first control valve (5) such that the same pressure is applied to the inlet side (500) of the first control valve (5) and to the second control connection (32) of the second control valve (3).

18. (New) A drive in accordance with claim 5, wherein the second control valve (3) has a second control connection (32) acting counter to the first control connection (30) and the second control connection (32) is in communication with the inlet side (500) of the first control valve (5) such that the same pressure is applied to the inlet side (500) of the first control valve (5) and to the second control connection (32) of the second control valve (3).

19. A drive in accordance with claim 17, wherein a line (14) extending between the working lines (12, 13) of the hydro machine is provided in which a shuttle valve (9) is arranged via which the inlet side (500) of the first control valve (5) and the second control connection (32) of the second control valve (3) can have pressure applied.

20. A drive in accordance with claim 18, wherein a line (14) extending between the working lines (12, 13) of the hydro machine is provided in which a shuttle valve (9) is arranged via which the inlet side (500) of the first control valve (5) and the second control connection (32) of the second control valve (3) can have pressure applied.
